(19) United States
(12) Patent Application Publication
(10) Pub. No.: US 2009/0274895 A1
(43) Pub. Date: Nov. 5, 2009

(54) DECORATIVE COATED PARTICLE AND ENGINEERED STONE CONTAINING SUCH PARTICLES

(75) Inventors: Kevin Bergevin, Kingston (CA); Kimberley L. Reid, Napanee (CA); Jocelyn M. Willis-Papi, Kingston (CA)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/432,430

(22) Filed: Apr. 29, 2009

Related U.S. Application Data
(60) Provisional application No. 61/126,264, filed on May 2, 2008.

(51) Int. Cl. B32B 5/16

(52) U.S. Cl. 428/323; 428/403

(57) ABSTRACT

A coated decorative refractive particle contains a transparent coating and either reflective particles or refractive particles embedded in the coating. Also an engineered stone contains such coated decorative particles.

### BACKGROUND OF THE INVENTION

1. Field of Invention

This invention is directed to a decorative coated particle preferably having abrasion resistance and to an engineered stone containing such particles.

2. Description of the Related Art

Engineered stone products may be produced by a well known procedure commercialized by Breton S.p.A. of Castello di Godego, Italy, so-called “Breton Stone”. In this technology, resin precursors are blended at low weight percentages with crushed stone aggregate to provide a relatively dry mass of material, distributed evenly on a support carrier, vibro-compacted under vacuum and then cured to yield a rigid product. A process used to practice this technology is disclosed by Toncelli in U.S. Pat. No. 4,698,010. Breton Stone materials are disclosed for use as flooring tile. Subsequent improvements to the technology, such as U.S. Pat. No. 6,387,985 to Wilkinson and Burchfield increased the uses of the material for general surfacing, particularly making it suitable for use as a countertop. Zodiaq® Quartz Surfacing from DuPont is an example of a commercially available engineered stone. Whether the product is floor tile or countertop, the slab produced by the Breton Stone process requires calibration to render it planar and uniform in thickness, as well as to reveal the aesthetic features of the product. This is followed by polishing to render the surface glossy.

As described in U.S. Pat. No. 6,387,985, materials may be added for a decorative effect. Decorative additives are distinguished from stone fillers primarily by the amount present in the composition. The crushed natural stone filler acts as an aggregate and is typically present in the a range from 85% to 95% by weight. Decorative additives such as gemstones, metal flake or filings, micas, seashells, pearls, colored or transparent polymeric particles, mirrored particles and pigments have been added in attempts to increase the visual appeal and aesthetic qualities of the engineered stone. However, these quantities typically have not exceeded about 5% by weight, and preferably, do not exceed 2% by weight. The decorative additives are thoroughly mixed with the other components during the blending, or placed on the surface subsequent to distribution on the support carrier and prior to vibro-compaction.

However a limiting factor in the incorporation of a decorative additive is due to contact with heavy aggregates during manufacture of the final article. Such aggregate can act to minimize or destroy the desired decorative effect of the additive.

There is a need for an additive which imparts a decorative appearance wherein the additive will remain intact during blending and compacting with heavy aggregates. Also there is a need for an additive which imparts an attractive visual appearance and preferably has abrasion resistance.

### SUMMARY OF THE INVENTION

The present invention is directed to a decorative coated particle comprising;

(a) a refractive particle;

(b) a transparent coating on the refractive particle of (a);

(c) reflective particles or refractive particles embedded in the transparent coating of (b),

with the proviso that only one of the reflective or refractive particles are present.

In a preferred mode the reflective particles or the refractive particles of (c) are primarily at a surface of the transparent coating.

Also the present invention is directed to an engineered stone containing the decorative coated particles.

### DETAILED DESCRIPTION OF PREFERRED EMBODIMENTS

### Transparent Particles

The first required component of the invention is a transparent particle which has the ability to refract light. The degree of transparency of the particle may vary; illustratively a translucent particle may be employed. Glass and transparent quartz are preferred materials for such particle.

The transparent particle which refracts light may vary in size. A particle having a size in a ranging from 10 mesh to 3 mesh is preferred, since larger sizes may not be suitable in a manufacturing process without being fractured. A larger particle can be used with proper process manufacturing parameters. The surface of the transparent particle can be planar, but curved and multifaceted surfaces are of interest aesthetically. It is understood that both larger and smaller particles may be employed. However, generally at least 50% and more preferably 80% of the transparent, refractive particles will be present in the ranges set forth above in a final product for incorporation within an engineered stone.

### Coating

A coating is applied to the transparent refractive particle which coating in a preferred mode provides abrasion resistance. Also the coating serves as a binder to hold additional particles as will be more fully described below. A preferred coating comprises a polyester which typically prior to polymerization contains coupling agent and catalyst. An example of a suitable polyester coating is described in U.S. Pat. Nos. 3,278,662 and 5,321,055. Also an acrylic coating can be employed such as disclosed in U.S. Pat. No. 6,387,985. The coating prior to polymerization typically has a viscosity in a range from 1000 to 10,000 centipoise, preferably in the range from 4000 to 6000 centipoise to effectively coat the transparent refractive particle.

### Additives in Coating

In order to obtain the decorative effect in the coated particle it is necessary to have a further additive present in the coating which either refracts light or reflects light. A combination of two additives which refracts light and reflects light to create a shimmering effect is the subject of a separate invention and lies outside the scope of the present invention.

An example of an additive which reflects light is a metal (such as copper and brass) which also includes alloys. Additional examples includes mica, holographic particles, metallized polyesters and reflective polymers including pearlescent and fluorescent pigments. Examples of a second additive which refract light are glass and transparent quartz.

The additive which either reflects or refracts light will be in particle form and will be embedded within the coating. In a preferred mode the additive will be concentrated near the surface of the coating (i.e. the surface which does not contact the innermost transparent refractive particle to which the coating is applied). However it is understood that the particles may be uniformly present, or have a degree of uniformity throughout within the transparent coating. The concentration and size of the particles is not critical with the understanding that both concentration and size affect the desired visual appearance and it is necessary for the particles to be embedded within the transparent coating.

For purpose of illustration an example of a particle size is in a range from 1 micron to 3 millimeters. Generally if particles are concentrated near the surface of the coating, the size will be smaller. An example of a size for such particle is in a range from 325 mesh to 34 mesh.

A further beneficial effect is present from the additive which is concentrated at the surface of the coated particle. Such benefit adds to minimize or eliminate agglomeration of coated particles since a number are formed at the same time. Additionally with suitable selection an additive can be employed which has superior resistance to abrasion. In a preferred mode the decorative coated particle presents a uniform color to an observer (such as a person with 20/20 observing at a distance of three feet from a coated particle or series of coated particles).

As previously set forth, a combination of two additives which refract and reflect light and imparts a shimmering appearance lies outside the scope of the present invention. A test as to whether a shimmering effect is present is by a person with 20/320 vision observing at a distance of three feet from a coated particle or series of coated particles. A single particle observation for purposes of this disclosure is labeled test method A while multiple particle observation is labeled test method B).

In a less preferred embodiment of the present invention, a combination of these two additives can be employed provided one of the two additives is present in a low concentration and does not impart a shimmering visual appearance. An example of a low concentration is not greater than 10 percent by weight of the total amount of the two additives, and generally will be less than 5 percent. A reason for a combination of two additives is due to cost with an expensive additive and a cheaper additive serving as a diluent.

### Engineered Stone

The coating decorative particles described above are suitable for incorporated into an engineered stone. Such engineered stone is well known in the art and is specific to a naturally occurring mineral in combination with a binder and other additives. Typically the engineered stone contains 85 to 95% by weight mineral and the remainder binder (on a basis of mineral and binder). A preferred engineered stone contains quartz in the amount stated with binder such as polyester or acrylic. The binder may be the same binder as employed for the coating of the particles. The amount of coated particles to impart a decorative effect is not critical but illustratively will be present in an amount of at least 5 percent by weight of the final composition.

The engineered stone is typically manufactured in the form of a slab, also known as a sheet. The decorative coated particle has an ability to withstand the weight and abrasion present in manufacture of the engineered stone.

### Manufacture

The decorative coated particle is formed by applying the transparent coating to a reflective particle wherein prior to solidification of the coating a reflective or refractive additive are present. The decorative coated particle is added to the engineered stone (which manufacture is well known such as set forth in the Background of the Invention). The decorative coated particle can be introduced into an abrasive mixture and can undergo vibration and compaction without loss of the coating.

The decorative coated particle may be added at a later stage of a manufacturing process to minimize abrasive contact. Typically, this latter addition would require the coated particle be hand placed on the surface of the uncured mix and compacted into the topmost portion of the mix. This is more labor intensive and less efficient. It will also result in coated particles present primarily on the topmost surface and leading to an uneven appearance along edge portions of the engineered stone.

Typically an engineered stone material is calibrated to remove surface material for uniformity and is polished.

It is understood that conventional additives may be added to coated particles and/or the engineered stone composition.

The following examples are provided to further illustrate the present invention. All parts and percentages are by weight unless otherwise indicated.

### EXAMPLES 1-5

TABLE 1

| Sample | | | Glass | |
|---|---|---|---|---|
| ID | Additive (Pigment) | Pigment Description | Colour | Effect Produced |
| 1 | Afflair ® 9235 | Pastel Green Metallic Pigment | Clear | Uniform (solid) coloured glass particles |
| 2 | Afflair ® 9236 | Pastel Green Metallic Pigment | Green | Uniform (solid) coloured glass particles |
| 3 | Afflair ® 9504 | Burgandy Metallic Pigment | Clear | Uniform (solid) coloured glass particles |
| 4 | Afflair ® 9500 Bronze WR | Bronze metallic Pigment | Clear | Uniform (solid) coloured glass particles |
| 5 | Afflair ® 9500 Bronze WR | Bronze metallic Pigment | Brown | Uniform (solid) coloured glass particles |

The following materials are used.
¼×8 Mesh Glass (Clear, Brown or Green)

### 30×50 Mesh Fine Crushed Clear Glass

Valspar Promoted Quartz Casting Resin 5766C00012 with approximately 25% Styrene

### Luperox 26M50 Peroxide

### Siloquest A-174 Coupling Agent

Additive (pigment) as listed TABLE 1
Pour 100 grams of resin into a plastic container. Add 1 gram of both Luperox 26M50 and Siloquest A-174 to the resin and stir until mixed. To this mixture add 5 grams of additive pigment and stir until completely mixed.
Put ¼×8 Mesh glass particles of various colors (green, brown and clear, as specified in TABLE 1) into a 4 oz sample cup. Add a small amount of the resin mixture to the glass particles in the sample cup and stir using a plastic stir rod. Add resin and stir until all the glass particles in the cup are uniformly coated with the resin mixture in an amount of approximately 12-14% by weight of the binder resin. Transfer the coated glass particles to a large strainer to allow for any excess resin to drip off the glass particles. Transfer the coated glass particles to a pail filled with the clear 30×50 Mesh fine glass. Stir the coated particles in the fine glass until the fine glass coats the glass particles. Repeat the above process until there is a quantity of coated particles in the fines. Pour excess glass fines through a sieve to separate the glass fines from the coated glass particles.
Spread the coated particles evenly on a baking sheet and place in an oven and cure the resin at 120 degrees Celsius for 45 minutes.
The coated particles with glass fines embedded therein are suitable in the manufacture of an engineered stone slab.

Materials

| | | | |
|---|---|---|---|
| 1.466 | kg | Titanium Dioxide (Ti02) | pigment |
| 0.070 | kg | Peroxide | catalyst |
| 6.400 | kg | Valspar | resin |
| 0.104 | kg | Siloquest A-174 | silane coupling agent |
| 4.550 | kg | Coated Particles | additive |
| 13.410 | kg | 10 mesh quartz | aggregate |
| 21.556 | kg | 34 mesh quartz | aggregate |
| 7.900 | kg | 84 mesh quartz | aggregate |
| 18.450 | kg | 325 mesh quartz | aggregate |

Place the above materials in a mixer and blend for 215 seconds. Conveyed the materials to a lay down frame and distribute onto a support carrier. Convey the support carrier with distributed mix into a vibro-compacter and compact the materials. After vibro-compaction, the materials are conveyed into an oven and cured to form a slab of engineered stone. Polish the engineered stone slab to achieve a final article having a desired decorative effect.

What is claimed is:

1. A decorative coated particle comprising:
(a) a refractive particle,
(b) a transparent coating on the refractive particle of (a);
(c) reflective particles or refractive particles embedded in the transparent coating of (b), with the proviso that only one of the reflective or refractive particles are present.

2. The decorative coated particle of claim 1,
wherein the reflective particles or the refractive particles of(c)are primarily at a surface of the transparent coating

3. The coated particle of claim 1,
wherein the refractive particle of (a) is glass.

4. The coated particle of claim 1,
wherein the transparent coating of (b) comprises a polyester containing polymer.

5. The coated particle of claim 1,
wherein the transparent coating of (b) comprises an acrylic containing polymer.

6. The coated particle of claim 1,
wherein the reflective particles of (c) are metal.

10. The coated particle of claim 1,
wherein the refractive particles of (d) are glass.

11. The coated particle of claim 1,
wherein (a) is glass, (b) comprises a polyester containing polymer, (c) is metal or glass.

12. An engineered stone sheet having comprising naturally occurring mineral in particle form and a binder,
wherein the sheet additionally contains a number of decorative coated particles comprising:
(a) a refractive particle;
(b) a transparent coating on the refractive particle of (a);
(c) reflective particles or refractive particles embedded in the transparent coating of (b), with the proviso that only one of the reflective or refractive particles are present.

13. A decorative coated particle comprising:
(a) a refractive particle,
(b) a transparent coating on the refractive particle of (a);
(c) reflective particles and refractive particles embedded in the transparent coating of (b), with the proviso that a shimmering appearance is not present.
